(19) United States
(12) Patent Application Publication
(10) Pub. No.: US 2009/0107313 A1
(43) Pub. Date: Apr. 30, 2009

(54) Assembled blind cutting machine

(75) Inventors: Ming Nien, Changhua County (TW); Wen-Yu Lee, Tainan City (TW)

Correspondence Address: BIRCH STEWART KOLASCH & BIRCH, PO BOX 747, FALLS CHURCH, VA, 22040-0747, US

(73) Assignee: NIEN MADE ENTERPRISE CO., LTD.

(21) Appl. No.: 11/979,051

(22) Filed: Oct. 30, 2007

(51) Int. Cl. B26D 5/20

(52) U.S. Cl. 83/76.8

(57) ABSTRACT

An assembled blind cutting machine is provided. The assembled blind cutting machine includes a control console and at least a cutting device capable of moving to and fro along a pre-determined direction; each of the cutting devices having at least a cutting member; a linking member formed across between the control console and each of the cutting devices so as to integrate each of the cutting devices and the control console. Consequently, by matching cutting devices of different cutting members with the control console, the assembled blind cutting machine offers more options and enhanced extensibility.

### BACKGROUND OF THE INVENTION

1. Field of the Invention

The present invention relates to a cutting machine for cutting parts of window covering, particularly an assembled blind cutting machine of more options and enhanced extensibility.

2. Description of the Prior Art

Cutting machines are often set up inside self-service blind stores for service staff or customers to cut window covering parts (for example, valances, rails, slats, etc.) depending on the size of window covering parts required.

Given differences in the materials and structures of window covering parts, different types of cutting members (for example, blade cutting members, saw blade cutting members, etc.) are required for cutting. Consequently, diverse cutting members are usually installed at two ends of the same cutting machine for customer service.

Referring to FIG. 1, in order to facilitate efficient utilization of space in the store, a cutting machine 8 is usually stored into a rack 9 via a roller guide 80. Given that the volume of the cutting machine 8 is minimized as far as possible, materials such as rails or valances may be longer than the cutting machine 8. Consequently, it is necessary to disposed different cutting members 81, 82 at two ends of the cutting machine 8 into downwards-folded structures. In other words, accommodation spaces 83, 84 are formed on each of the two ends of the cutting machine 8 respectively for receiving cutting members 81, 82. Sliding members and stationary members (not shown in the drawing) are disposed inside each of the accommodation spaces 83, 84 to allow the upwards and downwards sliding of the cutting members 81, 82, such that the not-in-use cutting member 82 is folded into the accommodation space 84, while the in-use cutting member 81 is moved upwards to a top working surface of the cutting machine 8 to allow the cutting of rails or valances on a workbench 85. The designs of other related moveable cutting members have been disclosed in the U.S. Pat. No. 6,604,443.

Nonetheless, the following problems are inherent in the above cutting machine:

1. Given that the cutting members 81, 82 need to be slidably installed inside the accommodation spaces 83, 84, the cutting members 81, 82 and the accommodation spaces 83, 84 should be integrated. However, with this integrated design, the cutting machine is unable to match with cutting members of diverse functions. Moreover, other machines and tools for cutting window covering parts are unable to be integrated into the cutting machine 8. In other words, the cutting machine lacks options and extensibility. Consequently, the cutting machine is necessary to be improved.
2. Considering that the two cutting members 81, 82 are usually folded into the accommodation spaces 83, 84 of the cutting machine 8, the weight of the entire cutting machine 8 needs to be overcome, regardless of whether the cutting machine 8 is pulled out from the rack 9 or folded into the rack 9. This poses a great burden to ordinary consumers, particularly female. Moreover, given all the members are integrated, more burdens are exerted on the roller guide 80, thus causing a shorter service life of the cutting machine 8.
3. Given that the two cutting members 81, 82 are set up on a sliding member, the cutting members 81, 82 slide upwards to the top working surface of the cutting machine 8 via the sliding member, when there is a need in using the cutting members 81, 82. Moreover, the cutting members 81, 82 are fixed through a stationary member. In other words, the cutting members 81, 82 are not directly securely attached onto the cutting machine 8, thereby affecting the strength and stability of the cutting members 81, 82.

### SUMMARY OF THE INVENTION

To overcome the above drawbacks, an object of the present invention is to provide an assembled blind cutting machine, which is designed as a self-contained machine to be connected to a control console in order to enhance options and extensibility.

Another object of the present invention is to provide a cutting machine with each cutting member formed as a self-contained apparatus having an independent slide guide in order to enhance the strength and the stability of the cutting machine when using it.

To achieve the above objects, the assembled blind cutting machine of the present invention includes a control console and at least a cutting device capable of moving to and fro along a pre-determined direction respectively; each cutting device having at least a cutting member; a linking member formed across between the control console and each cutting device so as to integrate each of the cutting devices and the control console and allow each of the cutting devices to move synchronously with the control console along the pre-determined direction.

Given that the cutting device is a self-contained apparatus, cutting devices having different types of cutting members work in cooperation with the control console to enhance options and extensibility of the cutting machine, such as it can be used to cut down a fabric blind, a vertical blind, a wood blind, a metal blind, a roman shade, a pleated shade or a cellular shade etc.

Moreover, each cutting device is formed into a self-contained apparatus through a slide guide therein, thereby improving the strength and the stability of each cutting device and enhancing the safety during cutting.

To enable a further understanding of the objectives and the technological methods of the invention herein, the brief description of the drawings below is followed by the detailed description of the preferred embodiments.

### BRIEF DESCRIPTION OF THE DRAWINGS

FIG. 1 is a schematic view showing the structure of a conventional cutting machine;

FIG. 2 shows an external perspective view of the present invention;

FIG. 3 is an external perspective view showing the installation of the present invention on a rack base;

FIG. 4 shows a partial enlargement of a first cutting device made according to the present invention;

FIG. 5 shows an external perspective view of the internal structure of the first cutting device made according to the present invention;

FIG. 6 shows a partial enlargement of a second cutting device made according to the present invention;

FIG. 7A is a schematic view (I) of the in-use condition of the linking member made according to the present invention;

FIG. 7B is a schematic view (II) of the in-use condition of the linking member made according to the present invention; and

FIG. 8 is a schematic view of the in-use condition of the present invention.

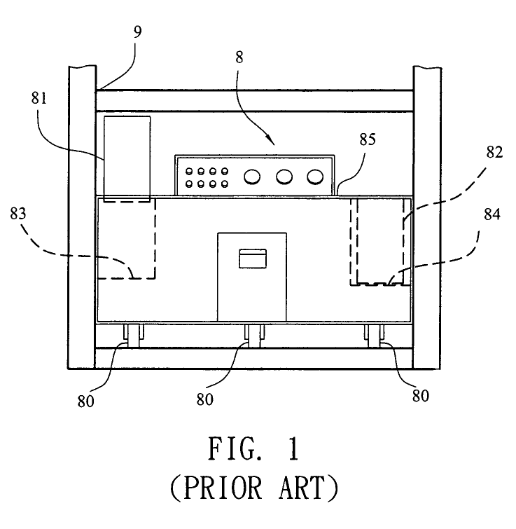

### DETAILED DESCRIPTION OF THE PREFERRED EMBODIMENTS

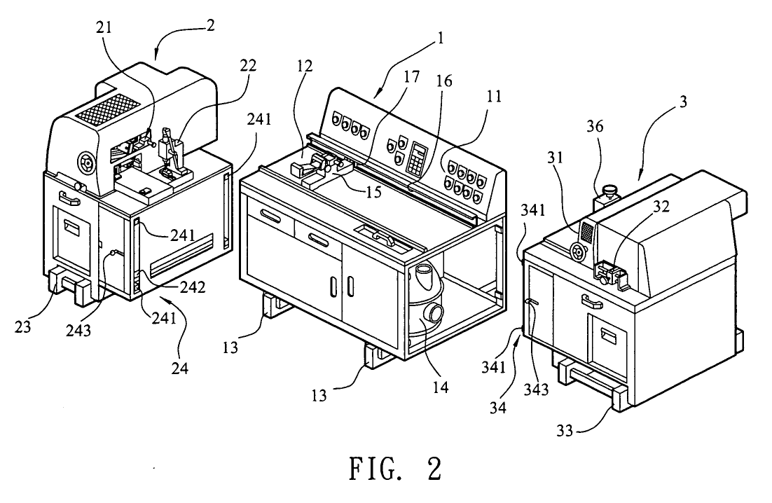

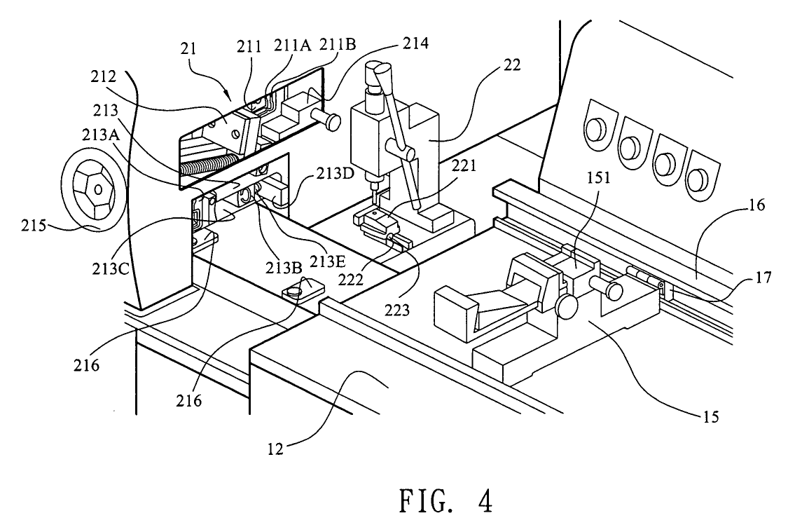

FIGS. 2 to 8 show the structures of a first preferred embodiment disclosed in the present invention.

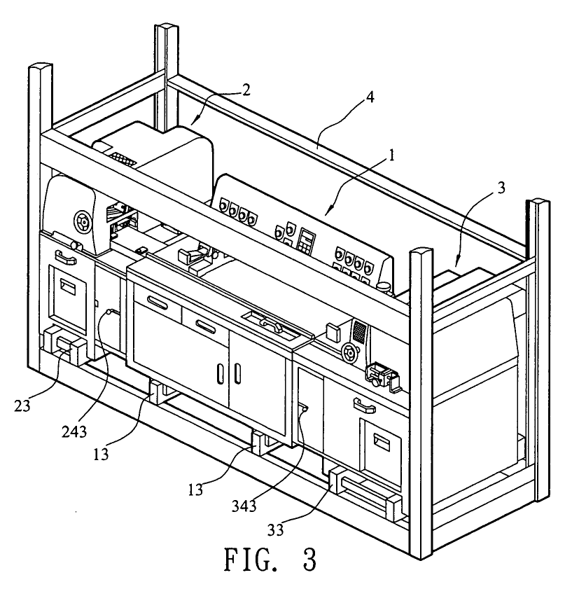

Referring to FIGS. 2 to 3, the assembled blind cutting machine of the present embodiment is formed by a control console 1 as well as a first cutting device 2 and a second cutting device 3 respectively formed on two sides of the control console 1.

The control console 1 includes an operating panel 11 capable of operating the first cutting device 2 and the second cutting device 3 as well as a workbench 12. The control console 1 is installed inside a rack base 4, and moves along an extension of a slide guide 13 pre-configured on the rack base 4. In addition, the control console 1 is provided with a vacuum cleaner 14 therein.

A rail 16, including a sliding block 17, is formed on the workbench 12. The sliding block 17 is pivotally connected to a support frame 15, which is used for supporting the to-be-cut window covering parts for cutting. Consequently, the support frame 15 can slide on the workbench 12 through the coordination of the rail 16 and the sliding block 17. The support frame 15 can be lifted upwards, creating clearance on the workbench 12 if the support frame 15 is not in use.

The first cutting device 2 is a self-contained apparatus on which a first cutting member 21 and a keypunch 22 are disposed. The first cutting device 2 arranged in a self-contained manner on the rack base 4 can move along an extension of a slide guide 23 formed on the rack base 4. On the other hand, a first linking member 24 is formed on a face of the first cutting device 2 adjacent to the control console 1 corresponding to the control console 1. The first linking member 24 includes at least one moveable coupler 241, each of which is connected to one another by a rack body 242. The rack body 242 is provided with an operating rod 243, which protrudes from a front side face of the first cutting device 2.

The second cutting device 3 is a self-contained apparatus on which a second cutting member 31 and a positioning ruler set 32 are disposed. The second cutting device 3 arranged in a self-contained manner on the rack base 4 can move along an extension of a slide guide 33 formed on the rack base 4. On the other hand, a second linking member 34 is formed on a face of the second cutting device 3 adjacent to the control console 1 corresponding to the control console 1. The second linking member 34 includes at least one moveable coupler 341, each of which is connected to one another by a rack body (not shown in the drawing). The rack body is provided with an operating rod 343, which protrudes from a front side face of the second cutting device 3.

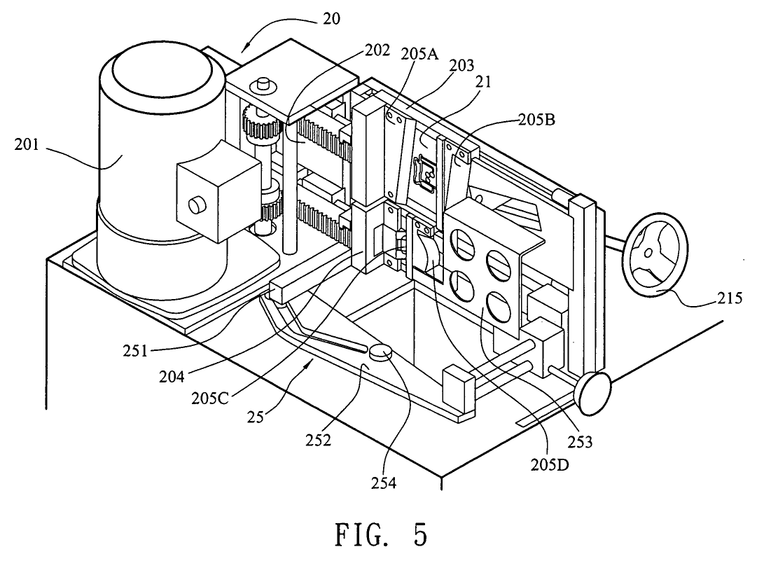

Referring to FIGS. 2, 4 and 5, a blade set 20 (as shown in FIG. 5), a head rail cutting mold 211, a cellular shade clamper 212 and a horizontal blind clamper 213 are provided inside the first cutting member 21.

Referring to FIG. 5, the blade set 20 includes two parallel slidably tool post 203 drived by a motor 201 and a gear set 202 to slide on the first cutting member 21. Two blades 205A, 205B, 205C and 205D respectively installed on the two parallel slidably tool posts 203, 204 are respectively independently locked and joined on the tool posts 203, 204, such that the blades 205A, 205B, 205C and 205D may be separately dismantled and changed when being worn down, so as to enhance operating convenience. Additionally, the blades 205A, 205B, 205C and 205D are formed on the tool posts 203, 204 by forming a bevel angle with diverse cutting molds and clampers. Incision is made from an angle of a blind cutting face, thus leveling the blind cutting face.

The head rail cutting mold 211 applied for cutting independent head rails includes two mold cavities 211A, 211B of different dimensions and specifications, which are overlapped on one another at a pre-determined location, such that the head rail cutting mold 211 can be used for cutting head rails of different dimensions and specifications.

A moveable block 214 formed on a front end of the head rail cutting mold 211 is used depending on the needs for cutting. In other words, after the to-be-cut head rail passing through the mold cavities 211A or 211B of the head rail cutting mold 211 is not at a horizontal position with the support frame 15, a front end of the head rail is elevated using the moveable block 214. In coordination with another moveable block 151 formed on the support frame 15, the height of the head rail is adjusted, such that the to-be-cut head rail can be horizontally placed across the support frame 15.

After using the cellular shade clamper 212 for the passing of cellular shades, the cellular shades are tightly clamped using a hand wheel 215 for cutting. The cellular shade clamper 212 slantingly formed on the first cutting device 2 forms an included angle of 55 to 75° between an extension of cellular material and an edge of the blade 205B, thereby preventing the rupture of the head rail or the bottom rail of the to-be-cut blinds and smoothening the cross section.

The horizontal blind clamper 213 including a head rail mold 213A, a bottom rail mold 213B and a slat insert-hole 213C is used for cutting the entire set of blinds. When cutting, a head rail is passed through the head rail mold 213A; a bottom rail is passed through the bottom rail mold 213B; blind blades or slats are passed through the slat insert-hole 213C. The entire set of blinds is tightly clamped using a push plate 213D for cutting. The head rail mold 213A includes two mold cavities of different dimensions and specifications, which are overlapped on one another at a pre-determined location. A moveable block 216 formed on a front end of the head rail mold 213A is used depending on the needs for cutting. In other words, after the to-be-cut head rail passing through the head rail mold 213A is not horizontal placed on a workbench of the first cutting device 2, the height of the head rail can be adjusted using the moveable block 216, such that the head rail is stably positioned on a surface of the workbench.

A magnet 213E is formed between the bottom rail mold 213B and the push plate 213D for the convenient to operation, such that the bottom rail mold 213B is taken out by pushing the push plate 213D backwards after cutting, in order to increase the interval between the bottom rail mold 213B and the slat insert-hole 213C, thus facilitating subsequent cutting.

A hole-punching mold 221 is formed on a bottom platform of the keypunch 22 for the head rail of the blind to prop up and become positioned. On the other hand, a penetrating hole 222 is formed on a side of the hole-punching mold 221, while a guiding portion 223 is formed on a front of the penetrating hole 222. The penetrating hole 222 is used for the passing of a rotation rod of the blind. When the head rail is placed in front of the hole-punching mold 221 of the keypunch 22 and is horizontally pushed toward the hole-punching, the rotation rod formed in an interior of the head rail enters the penetrating hole 222 via the groove-shaped guiding portion 223.

An automatic baffle-retracting member 25, including a linkage 251, a baffle 253 and a guide 252, is formed inside the first cutting device 2. An end of the linkage 251 is connected to a tool post 204, whereas another end of the linkage 251 is slidably formed inside the guide 252. The guide 252 is pivotally formed on a stationary shaft 254, whereas an end not connecting to the linkage 251 is linked to the baffle 253, which is formed at a pre-determined location of the first cutting device 2 in a manner that moves along a pre-determined direction, such that the to-be-cut window coverings can pass through and prop up against the first cutting member 21 and become positioned. When cutting the window coverings, the guide 252 driven by the linkage 251 swings on the stationary shaft 254 at a pre-determined direction. The winding path on the guide 252 may force the baffle 253 to move in a direction away from the cellular shade clamper 212 and the horizontal blind clamper 213 without interfering with the cutting of window coverings. After cutting is completed, the guide 252 may be linked to force the baffle 253 to return to its original location. Moreover, the guide 252 may force the baffle 253 to move slidably without being pivotally formed on the stationary shaft 254.

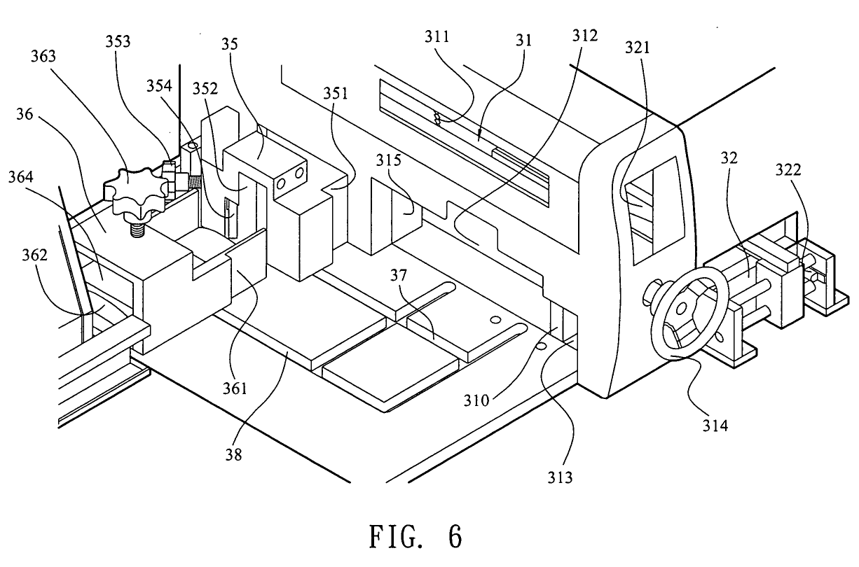

Referring to FIGS. 2 and 6, the second cutting member 31 includes a saw blade 311 and a cutter knife (not shown in the drawing) for different cutting needs. A saw blade insert-hole 312 and a blade insert-hole 313 are respectively formed in correspondence with the saw blade 311 and the cutter knife formed on the second cutting member 31.

A baffle 321 of the positioning ruler set 32 extended to an interior of the second cutting member 31 moves to and fro between a first location (near the saw blade 311) and a second location (away from the saw blade 311). The first location is used for restricting and positioning the length of blind-related components extended to the second cutting member 31, whereas the second location is used for touching a safety switch (not shown in the drawing, for example, the common niicro-switch) that controls the power source of the second cutting member 31.

When turning on power for cutting, once the baffle 321 is unable to touch the safety switch because the baffle 321 has not been retracted to the second location, the second cutting member 31 is unable to be started.

The safety switch also may be linked to a normally open alarm device (not shown in the drawing) and is closed only after the baffle 321 has been retracted to the second location.

The positioning ruler set 32 in the embodiment of the present invention can further include a safety lock 322 that is just located on the second location and is engaged with the baffle 321 for the user to confirm whether the baffle 321 has touched the safety switch.

Two slides 37, 38 are respectively disposed on a surface of the second cutting device 3, such that a valance bevel cut fixture 35 and a vertical slat fixture 36 are slidably formed inside the slides 37, 38 respectively. The valance bevel cut fixture 35 and the vertical slat fixture 36 respectively include inwardly indented positioning portions 351, 361, such that the valance bevel cut fixture 35 and the vertical slat fixture 36 may be displaced to the saw blade insert-hole 312 of the second cutting member 31 along the slides 37, 38, and may prop up against a prism 310 and a pre-determined location of the second device 3 for positioning via each positioning portions 351, 361 for the cutting of valances or vertical slats respectively.

The valance bevel cut fixture 35 includes a 45° trough 352 for valances to pass through. Through a rotary hand wheel 353, an active plate 354 is driven, such that the valances are tightly clamped for cutting.

The vertical slat fixture 36 includes an insert 362 for vertical slats to pass through. Through rotating a hand wheel 363, an active plate 364 is driven, such that the vertical slats are tightly clamped for cutting.

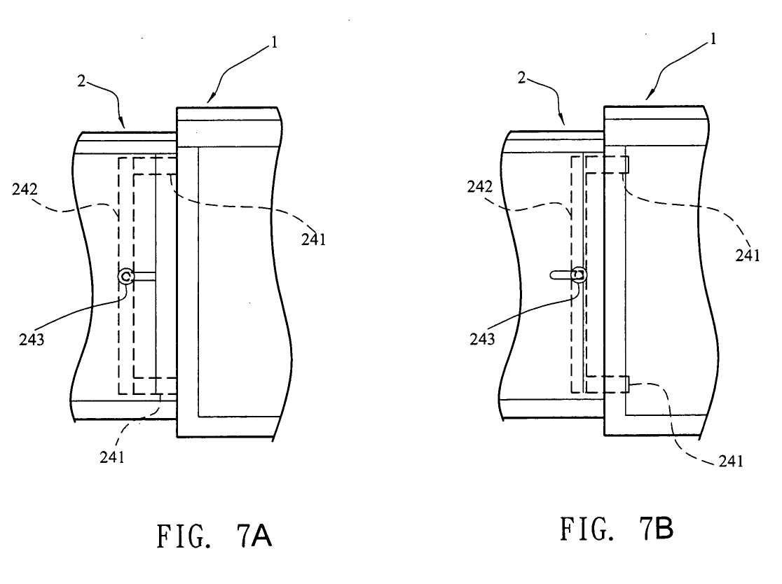

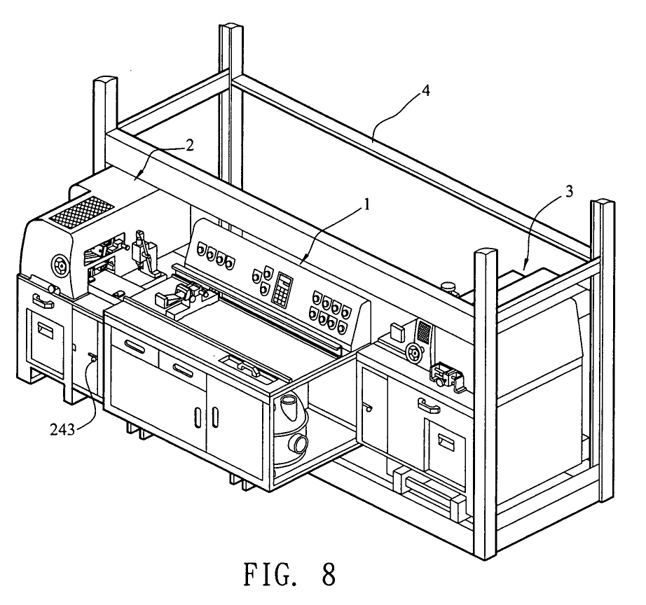

Either the first cutting device 2 or the second cutting device 3 may be selected depending on the cutting needs. For using the first cutting device 2 as an example, before using the present invention, the first linking member 24 is shown in FIG. 7A, whereas each coupler 241 is located inside the first cutting device 2. Before using the invention, the first linking member 24 is moved rightwards using the operating rod 243, while four couplers 241 are driven rightwards to be inserted into an interior of the control console 1 via the rack body 242 (as shown in FIG. 7B), such that the control console 1 and the first cutting device 2 are mutually linked. In this way, the user can easily pull out the control console 1 and the first cutting device 2 from the rack base 4 by the slide guides 13, 23 (as shown in FIG. 8) for related cutting. In addition to, before using the invention, the control console 1 and the first cutting device 2 are first pulled out from the rack base 4 to an end of an extension of slide guides 13, 23, and then integrated the control console 1 and the first cutting device 2 via the first linking member 24 to perform the cutting. Steps for cutting different window covering parts are described as follows:

1. When cutting horizontal blinds (except for wooden blinds), the control console 1 and the first cutting device 2 are linked and pulled out. The support frame 15 formed on the control console 1 is lifted upwards, creating clearance on the workbench 12. Then a head rail of the blinds is passed through the head rail mold 213A; blind slats are passed through the slat insert-hole 213C; a bottom rail is passed through the bottom rail mold 213B, until they are positioned. The entire set of blinds is tightly clamped using a push plate 213D for cutting. When the push plate 213D is retracted backwards after cutting, the bottom rail mold 213B absorbed by the magnet 213E formed between the bottom rail mold 213B and the push plate 213D will be automatically taken out backwards along with the push plate 213D.
2. When cutting cellular shades, the first cutting device 2 is selected. After adjusting the entire support frame 15 to an intended location, the to-be-cut end of the cellular shades is passed through the cellular shade clamper 212, whereas another end of the cellular shades is placed on the support frame 15. Cutting is performed after the cellular shades are positioned and tightly clamped.
3. When cutting wooden or wood-like slat blinds, the control console 1 and the second cutting device 3 are linked and pulled out. After adjusting the cutting size of the blinds by moving the positioning ruler set 32, the to-be-cut blinds are placed on corresponding insert-holes. For example, when the head rail of the to-be-cut blinds is made of non-iron materials, the entire set of wooden blinds is directly placed on the saw blade insert-hole 312. On the other hand, when the head rail of the to-be-cut blinds is made of iron materials, the iron head rail needs to pass through the blade insert-hole 313, whereas the slats and the bottom rail are placed on the saw blade insert-hole 312. After placing the to-be-cut blinds at a suitable insert-hole, the blinds are pushed until they are positioned. A push plate 315 is adjusted until the blinds are tightly clamped. Before cutting, the baffle 321 is moved until the second location comes into contact with the micro-switch so as to control the power source of the second cutting member 31 and turn on the power source. Cutting of the blades on the metallic head rail is performed before performing saw blade cutting. When the second cutting member 31 is turned on, the vacuum cleaner 14 is simultaneously turned on.
4. When cutting valances, cutting is performed on the second cutting device 3. The valance bevel cut fixture 35 is pushed to the saw blade insert-hole 312 along the slide 37 until the valance bevel cut fixture 35 is positioned. Through a rotary hand wheel 314, the push plate 315 is moved so as to clamp the valance bevel cut fixture 35. After adjusting the cutting size of the valances by moving the positioning ruler set 32, the to-be-cut valances pass through the trough 352 of the valance bevel cut fixture 35 until the valances are positioned. The active plate 354 is adjusted, such that the valances are tightly clamped for cutting.
5. When cutting vertical blinds, the first cutting device 2 and the second cutting device 3 are respectively used. When cutting head rails of vertical blinds, the control console 1 and the first cutting device 2 are mutually linked and pulled out. After the support frame 15 is adjusted to the intended location, the to-be-cut end of the head rail passes through the mold cavity 211A or 211B corresponding to the head rail cutting mold 211, whereas another end of the head rail is placed on the support frame 15. Cutting is performed after the head rail is pushed until it is positioned. When cutting slats of vertical blinds, the control console 1 and the first cutting device 2 are retracted and disconnected. Subsequently the control console 1 and the second cutting device 3 are mutually linked and pulled out, such that the vertical slat fixture 36 is pushed to the saw blade insert-hole 312 for being positioned along the slide 38. The rotary hand wheel 314 moves the push plate 315 to tightly clamp the vertical slat fixture 36. After adjusting the cutting size of the vertical slats by moving the positioning ruler set 32, the to-be-cut vertical slats pass through the insert 362 of the vertical slat fixture 36 until the slats are positioned. Cutting is performed after adjusting the active plate 364 and tightly clamping the vertical salts.

Except for choosing the first cutting device 2 or the second cutting device 3 alone, the same cutting device is installed at two sides of the control console 1. When the length of the to-be-cut object is shorter than the length of the working surface of the cutting machine, either the first cutting device 2 or the second cutting device 3 formed at two sides of the control console 1 is selected. In this way, the object needs only to be moved leftwards and rightwards for two-end cutting.

The first cutting device 2 or the second cutting device 3 is formed into a self-contained apparatus through the respective slide guides 23, 33 formed on the rack base 4, thereby improving the strength and the stability of the first cutting device 2 or the second cutting device 3 and enhancing the safety during cutting.

The first cutting device 2 and the second cutting device 3 of the present invention are designed into self-contained apparatus, which are formed into moduarlized designs with the control console 1. Consequently, it is possible to integrate related processing tools into the first cutting device 2 or the second cutting device 3 depending on the processing required for self-service window covering parts. For example, the multipurpose first cutting member 21 and the keypunch 22 are disposed on the first cutting device 2 in the present invention, whereas the second cutting device 31, the positioning ruler set 32, the valance bevel cut fixture 35 and the vertical slat fixture 36 are formed on the second cutting device 3 to meet different cutting needs. A support frame 15 is slidably disposed on the workbench 12 of the control console 1 to support the to-be-cut objects. Moreover, the vacuum cleaner 14 is set up inside the control console 1 for synchronous vacuuming so as to prevent the scattering of saw dust during cutting. Through such an integrated design, more options and enhanced extensibility can be achieved for the cutting machine of the present invention in order to provide consumers with diversified cutting, processing and more convenience.

Given the first cutting device 2 and the second cutting device 3 are integrated with the control console 1 as a self-contained apparatus, maintenance and repairs can be easily made. Even if breakdown occurs to the cutting device, the malfunctioned cutting device may be replaced alone to facilitate the operations of the entire cutting machine. Moreover, given diverse cutting devices are self-contained and modularized, different cutting members can be developed depending on the needs for cutting window covering parts, thereby allowing for diverse options and enhanced extensibility.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. An assembled blind cutting machine, for cutting window coverings, comprising: a control console and at least a cutting device capable of moving to and fro along a pre-determined direction respectively; said each cutting device having at least a cutting member; a linking member formed across between said control console and said cutting device so as to integrate said cutting device and said control console and allow said cutting device to move synchronously with said control console along said pre-determined direction.

2. The assembled blind cutting machine as claimed in claim 1, wherein said control console and said cutting device are jointly formed on a base and move along an extension of several slide guides pre-configured on said base.

3. The assembled blind cutting machine as claimed in claim 1, wherein said control console comprises a workbench and an operating panel capable of operating said cutting device.

4. The assembled blind cutting machine as claimed in claim 3, wherein a support frame is slidably formed inside said workbench for supporting to-be-cut window covering.

5. The assembled blind cutting machine as claimed in claim 4, wherein a rail securely provided on said workbench comprises a sliding block pivotally connected to said support frame, which moves along said rail or pivots relative to said sliding block.

6. The assembled blind cutting machine as claimed in claim 1, wherein said linking member formed inside said cutting device comprises at least one moveable coupler, each of which is connected to one another by a rack body; said rack body provided with an operating rod, which protrudes from a front side face of said cutting device; and by moving each coupler using said operating rod, each coupler can be inserted into said control console, such that said cutting device and said control console are linked.

7. The assembled blind cutting machine as claimed in claim 1, wherein said cutting member of said cutting device comprises at least a blade set which including a tool post drived by a motor and a gear set to slide on said cutting machine, at least a blade locked and joined on said tool post.

8. The assembled blind cutting machine as claimed in claim 1, wherein said cutting member of said cutting device comprises at least a head rail mold; said mold comprising two mold cavities of different dimensions and specifications for the passing of head rails of diverse dimensions and specifications for cutting.

9. The assembled blind cutting machine as claimed in claim 8, wherein said two mold cavities of said mold are overlapped at each respective pre-determined location.

10. The assembled blind cutting machine as claimed in claim 1, wherein said cutting member of said cutting device comprises at least a clamper, said clamper further comprising an head rail mold securely formed on said clamper, a bottom rail mold slidably formed on said clamper and a slat insert-hole formed between said head rail mold and said bottom rail mold; said bottom rail mold being displaced by a push plate; and a magnet formed between said bottom rail mold and said push plate for absorbing said bottom rail mold.

11. The assembled blind cutting machine as claimed in claim 1, wherein said cutting member of said cutting device comprises at least a saw blade for sawing said window covering.

12. The assembled blind cutting machine as claimed in claim 1, wherein at least a moveable block is formed on said cutting device corresponding to said cutting member for elevating to-be-cut window covering, such that said to-be-cut window covering horizontally pass through and extend into said cutting member.

13. The assembled blind cutting machine as claimed in claim 1, wherein said cutting device comprises a keypunch and a hole-punching mold corresponding to said keypunch; said hole-punching mold being provided for a head rail of said window covering to prop up and become positioned; and said hole-punching mold being provided with a penetrating hole, while a groove-shaped guiding portion being formed on a front of said penetrating hole.

14. The assembled blind cutting machine as claimed in claim 1, wherein said cutting device comprises an automatic baffle-retracting member; said automatic baffle-retracting member further comprising a linkage; a baffle formed on a pre-determined location of said cutting device along a pre-determined direction; and a guide formed between said linkage and said baffle; and driven by said linkage, said cutting member drives the retraction of said baffle during cutting.

15. The assembled blind cutting machine as claimed in claim 1, wherein said cutting device comprises a positioning ruler set, which comprises a baffle extended to an interior of said cutting member and moving to and fro between a first location near said saw blade and a second location away from said saw blade; said first location is used for restricting and positioning the length of to-be-cut window covering extended to said cutting member; whereas said second location is used for touching a safety switch that controls a power source of said cutting member.

16. The assembled blind cutting machine as claimed in claim 1, wherein said cutting device is provided with at least a slide for a fixture slidably formed inside, such that said fixture is displaced to a pre-determined location along said slide.

17. The assembled blind cutting machine as claimed in claim 16, wherein said fixture is provided with an inwardly indented positioning portion, which props up against a pre-determined location of said cutting device and becomes positioned.

18. The assembled blind cutting machine of claim 1, wherein the window covering comprises a fabric blind, a vertical blind, a wood blind, a metal blind, a roman shade, a pleated shade, or a cellular shade.

19. An assembled blind cutting machine, comprising: a first cutting device and a second cutting device respectively formed on two sides of a control console; two linking members respectively formed across between said control console and said first cutting device and across between said control console and said second cutting device; a cutting member of said first cutting device comprising a blade set, whereas a cutting member of said second cutting device comprising a saw blade and/or a cutting blade for cutting different window covering parts.

20. An assembled blind cutting machine, for cutting window coverings, comprising at least a cutting device, wherein at least a slide is provided on said cutting device; said slide allows a fixture to be slidably formed inside, such that said fixture can move to a pre-determined location along said slide.

21. The assembled blind cutting machine as claimed in claim 20, wherein said fixture provided with an inwardly indented positioning portion, which props up against a pre-determined location of said cutting device and becomes positioned via said positioning portion.

22. The assembled blind cutting machine as claimed in claim 20, wherein said cutting member of said cutting device further comprises a saw blade and/or a cutting blade.

23. The assembled blind cutting machine as claimed in claim 20, wherein said cutting device comprises a positioning ruler set, which comprises a baffle extended to an interior of said cutting member and moving to and fro between a first location near said saw blade and a second location away from said saw blade; said first location is used for restricting and positioning the length of to-be-cut window covering extended to said cutting member; whereas said second location is used for touching a safety switch that controls a power source of said cutting member.
